(19) United States
(12) Patent Application Publication
(10) Pub. No.: US 2015/0127581 A1
(43) Pub. Date: May 7, 2015

(54) Planning Tool for Determining a Future Cost of Retirement

(71) Applicant: BlackRock Index Services, LLC, New York, NY (US)

(72) Inventors: Charles A. Castille, III, New York, NY (US); Edward Daverman, San Francisco, CA (US)

(21) Appl. No.: 14/532,383

(22) Filed: Nov. 4, 2014

Related U.S. Application Data
(60) Provisional application No. 61/900,653, filed on Nov. 6, 2013.

(51) Int. Cl. G06Q 40/06

(52) U.S. Cl. CPC G06Q 40/06
USPC 705/36 R

(57) ABSTRACT

A future cost of retirement planning tool conveniently translates lump-sum investment amounts into a future lifetime annual income amount. This future lifetime annual income amount is predicted as a function of retirement date, future pre-retirement saving rate, retirement income goal, and investment portfolio composition. The planning tool also provides probability distributions (or other measurements of variability) of the predicted future lifetime annual income amount based on the foregoing factors. This information is presented to a user in a convenient graphical interface.

### CROSS REFERENCE TO RELATED APPLICATIONS

This application claims the benefit of U.S. Provisional Application No. 61/900,653, filed Nov. 6, 2013, which is incorporated by reference in its entirety.

### BACKGROUND

The present disclosure relates generally to retirement planning. Specifically, the present disclosure relates to a planning tool for determining a future cost of retirement.

As people live longer, the responsibility for retirement planning is shifting to individuals as underfunded defined benefit programs are replaced with defined contribution plans and IRAs. Many prospective retirees are unprepared for the complexity of planning and funding a retirement that meets their objectives. In addition to this lack of preparation, people nearing retirement face the “retirement problem”—that is, the problem of how to consume wealth efficiently in light of an uncertain lifespan and uncertain investment returns. Three fundamental challenges contribute to this “retirement problem”: investment risk, mortality risk, and ingrained behavioral issues. These challenges can cause problems for retirees on an individual basis and can also contribute to a broader problem as the Baby Boom generation nears retirement and as 70 million Americans will retire in the next 20 years.

Effective retirement planning requires managing uncertain returns and an uncertain lifespan even though these two factors are essentially unrelated. Additionally, the “retirement problem” can be compounded by economic conditions in which low yields and volatile returns are common. This is further complicated by uncertain life spans that can cause individuals to outlive their financial resources.

To address the challenges of effective retirement planning, investors and prospective retirees would benefit from a retirement planning tool that provides an analysis of the costs of acquiring a defined income from a future retirement date that lasts for the remainder of the retiree's life and that also provides analysis of the possible variability in the defined income based on the current financial condition of the prospective retiree.

### SUMMARY

Embodiments of the future cost of retirement planning tool (“the planning tool”) that are described herein can be used by investors, prospective retirees, and financial advisors to conveniently translate lump-sum investment amounts into a future lifetime annual income amount. This future lifetime annual income amount is predicted as a function of retirement date, future pre-retirement saving rate, retirement income goal, and investment portfolio composition. Furthermore, embodiments of the planning tool also provide probability distributions (or other measurements of variability) of the predicted future lifetime annual income amount based on the foregoing factors. This information is presented to a user in a convenient graphical interface, as is described herein and shown in the figures.

### BRIEF DESCRIPTION OF THE DRAWINGS

FIGS. 1A to 1D are examples of user interfaces of a future cost of retirement planning tool, in an embodiment.

FIG. 2 is a method flow diagram illustrating a method for determining a portfolio value at time t and a range of probable future incomes at the time t for a confidence interval, in an embodiment.

FIG. 3 is a table illustrating asset class risks and returns, in an embodiment.

FIG. 4 is a table illustrating an expected asset class correlation matrix, in an embodiment.

FIG. 5 is a table illustrating various estimates of future retirement income variability for an investment portfolio that does not include investments tracking a future cost of retirement index, in an embodiment.

FIG. 6 is a table illustrating various estimates of future retirement income variability for an investment portfolio that does include investments tracking a future cost of retirement index, in an embodiment.

FIG. 7 is a graph of annual savings prior to retirement versus a measure of variability in retirement income, in an embodiment.

FIG. 8A is a block diagram of a system environment for a future cost of retirement planning tool system, in an embodiment.

FIG. 8B is an example block diagram of an architecture of a future cost of retirement planning tool, in an embodiment.

The figures depict various embodiments of the present disclosure for purposes of illustration only. One skilled in the art will readily recognize from the following discussion that alternative embodiments of the structures and methods illustrated herein may be employed without departing from the principles described herein.

### DETAILED DESCRIPTION

### Overview

The described embodiments reference a future cost of retirement index. As described in U.S. patent application Ser. No. 14/053,036, which is incorporated by reference herein in its entirety, the future cost of retirement index is used to quantify the present value of future lifetime income. For example, the future cost of retirement index tracks an expected amount of present value that would be needed to purchase, upon a future target date (e.g., retirement), a fixed amount of income for life (e.g., a $1 per month annuity payment). An index level of the future cost of retirement index is set at the present value needed to provide $1 (or other amount) of periodic income for life starting in the future.

The embodiments disclosed herein describe user interface features and models that improve the precision and computational efficiency for determining financial behaviors (e.g., savings rate, portfolio selection of a given risk level vs. rate of return) that can produce a target lifetime income at a future date. The disclosed embodiments are different from conventional retirement calculators. Conventional calculators receive financial behaviors from a user (e.g., savings rate, portfolio selection) to calculate a possible total portfolio value at a future date from which a user can estimate a retirement income whereas the disclosed embodiments receive a target retirement income from the user and calculate the financial behaviors required to achieve an expected target retirement income.

Applying conventional calculators to embodiments of the present disclosure would produce imprecise results and be computationally inefficient. Conventional calculators typically receive the financial behavior inputs from a user and calculate a portfolio value at a retirement (or other target) date using Monte Carlo simulations. Applying these conventional Monte Carlo simulations by providing a target retirement income as an initial input value would require a system to first assume a set of financial behaviors (e.g., a savings rate, a rate of return) corresponding to the provided target retirement income, then calculate a retirement income based on the assumed set of financial behaviors using the conventional Monte Carlo methods, then determine whether the conventionally calculated retirement income is above or below the provided retirement target income. The system would then assume at least one more set of financial behaviors intended to achieve a conventionally calculated income closer to the target. Furthermore, this process would be repeated for each combination of portfolio risk value. vs rate of return. This iterative Monte Carlo process would be both time consuming and computationally intensive. When combined with the millions of users associated with any of a number of financial firms, this iterative Monte Carlo process quickly becomes too computationally inefficient to be a practical solution for assisting users in determining financial behaviors for achieving a retirement income target.

In contrast, the closed form solution of the embodiments described herein determines financial behaviors analytically and precisely using a selected portfolio risk level vs. rate of return and a provided target retirement income and avoids the computationally inefficient iterative Monte Carlo simulations described above. The embodiments described herein also dynamically incorporate the changing cost of future income as a function of time, which further complicates the iterative Monte Carlo simulation described above. Also, by relying on the CORI benchmark, described in U.S. patent application Ser. No. 14/053,036, which is incorporated by reference herein, embodiments of the present disclosure efficiently incorporate other factors that affect the future cost of retirement with reference to interest rate curves, annuity spreads (with Treasury curves), and mortality rates as incorporated in actuarial tables.

### User Interface

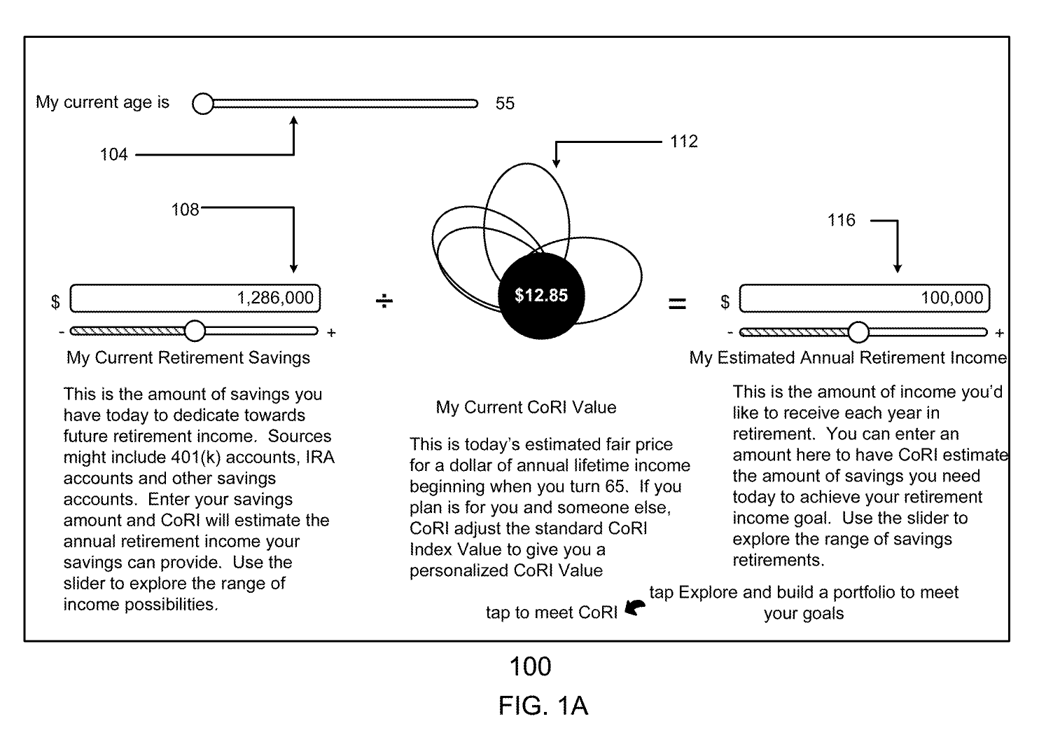

FIG. 1A illustrates one example of a user interface 100 of a planning tool for conveniently translating a lump-sum investment amount into a future lifetime income amount. The user interface 100 of the planning tool includes an age selector 104, a current retirement savings amount field 108, a present value of one dollar of future income (a “CORI value”) display 112, and an estimate annual retirement income display 116.

As is shown, a user provides a current age using the age selector 104 and enters a current retirement savings amount in the field 108. Based, in part, on the age value entered using the current age selector 104, the CORI value 112 is displayed. Calculation of the CORI value 112 is described more fully below and in U.S. patent application Ser. No. 14/053,036, which is incorporated by reference herein in its entirety.

The tool divides the current retirement savings amount in field 108 by the CORI value 112. This ratio determines the estimated annual retirement income 116 calculated according to Equation 1, where t is time, Iₜ is the estimated income generated by dividing a current retirement portfolio amount Pₜ by a future cost of retirement index level Cₜ.

$${I}_{t} = \frac{{P}_{t }}{{C}_{t}} \qquad ( 1 )$$

FIGS. 1B to 1D illustrate various configurations of a user interface that allows users to produce estimates of a future lifetime income, the present value of future lifetime income, and enter additional values of factors and assumptions used to model the future income. As shown in these figures, a user, using the planning tool, can determine the amount of additional annual savings needed to achieve an annual future income as a function of a present age, a current lump sum of investable savings, a future retirement date, a portfolio composition, and a confidence interval of the future income. As will be appreciated by comparing FIGS. 1B to 1D, and as explained in more detail below, the confidence of the estimate for achieving the predicted amount of annual lifetime income improves as the user selects a portfolio with a greater investment in a fund that tracks the CoRI index, as described in U.S. patent application Ser. No. 14/053,036.

FIG. 1B shows a user interface 120 in which a user has selected a moderate risk portfolio composition. Similar to the user interface 100 shown in FIG. 1A, the user interface 120 shown in FIG. 1B includes the current age selector 104 (set in this case at age 55) and the current retirement savings amount field 108. In addition, the user interface 120 also includes an annual retirement income target selector 124, an estimated annual retirement income display 128, an additional annual savings display 132, a retirement income range confidence interval 136, a retirement income range display 140, and a portfolio selector 144.

The annual retirement income target selector 124 enables a user to select, and have displayed, the income that the user desires during retirement. This display is useful for convenient reference and comparison to other fields and displays in the user interface 120. For example, having entered the target amount in the annual retirement income target selector 124, the user may then compare this amount to an estimated income range displayed elsewhere in the user interface 120 that is calculated using the methods described below.

The estimated annual retirement income display 128 displays the estimated annual retirement income calculated using the methods below and the values entered by the user in the user interface 120. For example, the methods described below use the age of the user entered into the current age selector 104, the current savings entered into the selector 108, a CORI value (not shown), and a portfolio (discussed below) to calculate the estimate annual retirement income that is then displayed in the display 128.

The additional annual savings display 132 displays the additional amount of annual savings needed for the user to achieve the income target selected in the selector 124. The additional annual savings displayed in display 132 is a function of not only the selected age, current retirement savings, and annual retirement income target, but also the portfolio selected, as will be described below. As with the estimated annual retirement income display 128, a benefit of the additional annual savings display 132 is that users can vary any of the various factors in the user interface 120 while simultaneously viewing the impact of the entered values of the various factors on the additional annual savings needed to accomplish the retirement income target of the display 124.

The income forecast confidence selector 136 is used to determine a range of likely retirement incomes, displayed in the retirement income range confidence interval display 140. The confidence range selector 136 allows a user to select a confidence level corresponding to a statistically probable range of income given an entered user age, portfolio selection, and current savings.

The portfolio selector 144 allows the user to select yet another factor used to determine the estimate annual retirement income displayed in the display 132 and the retirement income range confidence interval of the display 140. The portfolio selector 144 permits the user to select any of a variety of portfolios and their corresponding risk and return levels. In the user interface 120 shown in FIG. 1B, the “Moderate” risk level portfolio is selected, although other options including “Conservative,” and “Aggressive” may also be selected. Three other portfolio options shown in the portfolio selector 144 include CORI funds (such as those described in U.S. patent application Ser. No. 14/053,036, incorporated by reference herein in its entirety) are also available for selection at a variety of risk levels.

Upon selection of a portfolio by the portfolio selector 144, a mixture of various assets is displayed in a portfolio component display 148 and a portfolio component summary graph 152. Using the portfolio component display 148, a user may also adjust the various percentages of each component of a selected portfolio to customize the risk level desired. Adjusting the portfolio components in this way will cause the amount displayed in the additional annual savings display 132 and the income range displayed in the income range confidence interval display 140 to change accordingly.

FIG. 1C shows a user interface 156 similar to the user interface 120 shown in FIG. 1B except, as indicated by highlighting in portfolio selector 144, with a moderate risk portfolio composition selected that includes a CORI fund tracking a future cost of retirement index with a moderate risk level. While the values entered by the user in the current age selector 104, the current savings entered into the selector 108, the annual retirement income target selector 124, and the value displayed in the estimated annual retirement income display 128 are unchanged compared to the user interface 120 of FIG. 1B, the amount of additional annual savings displayed in additional annual savings display 132 and the income range displayed in the income range confidence interval display 140 have both decreased. This reflects the benefits of the inclusion of CORI funds in a portfolio. The calculations used to produce the values displayed in the displays 132 and 140 are described below.

FIG. 1D shows a user interface 160 in which a user has selected in portfolio selector 144 a conservative risk portfolio composition that includes a CORI fund tracking a future cost of retirement index with a conservative risk level. As shown, the values entered by the user in the current age selector 104, the current savings entered into the selector 108, the annual retirement income target selector 124, and the value displayed in the estimated annual retirement income display 128 are unchanged compared to the user interface 120 of FIG. 1B and the user interface 156 of FIG. 1C. However, the amount of additional annual savings displayed in additional annual savings display 132 has increased, but the income range displayed in the income range confidence interval display 140 has decreased. As with FIG. 1C, this difference reflects the benefits of the inclusion of CORI funds in a portfolio.

### Determining a Retirement Income Distribution

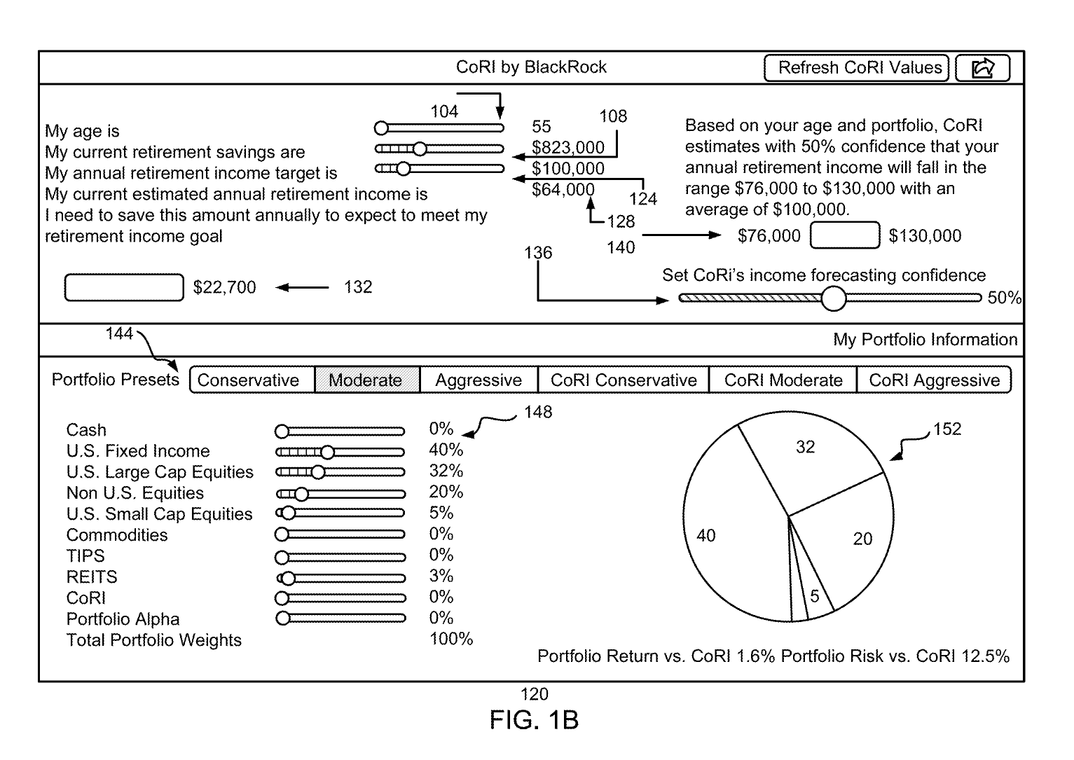

The various elements executed by models underlying the user interfaces illustrated in FIGS. 1A to 1D are shown in FIG. 2. The models are described below in the context of the elements of FIG. 2. As mentioned above, a lump-sum investment amount (also referred to as an initial portfolio value) is received 204 in the current retirement savings amount field 108. A user age is also received, as described above. A cost of retirement index value is determined 208 for a time t 208, as described above. The received initial portfolio value is translated to a future cost of retirement annual income for life using Equation 1. However, the value of a portfolio can increase as a function of time, portfolio investment composition, and other factors.

A value Pₜ of a portfolio at time t is also determined 212 based on the above values using Equation 2. In Equation 2, the portfolio value at time t is represented by Pₜ, ko, σₚ is a risk value, P₀ is an initial portfolio value, S₀ is an initial savings rate (as a percentage of a portfolio value P), k is a desired percentage increase in annual savings, and Bₜ^{P} is a Brownian motion term normally distributed with mean zero and variance t.

$${P}_{t} = {P}_{0} [ \frac{{S}_{0} ( {e}^{( k - {r}_{p} ) t} - 1 ) + k - {r}_{p}}{k - {r}_{p}} ] {e}^{( {r}_{p} - \frac{{σ}_{p}^{2}}{2} ) t + {σ}_{p} {B}_{t}^{p}} \qquad ( 2 )$$

While the expected value Pₜ increases over time, so too does the index level of a future cost of retirement index, which is also determined 212. The change of the future cost of retirement index value is due in part to a decreasing discount period as time passes and the identified retirement date draws nearer. The index level changes, in an embodiment, according to Equation 3, where C₀ is an initial index level at t=0 and Bₜ^{c} is a Brownian motion term with mean zero and variance t whose correlation with a portfolio is given by the coefficient ρ.

$${C}_{t} = {C}_{0} {e}^{( {r}_{c} - \frac{{σ}_{c}^{2}}{2} ) t + {σ}_{c} {B}_{t}^{c}} \qquad ( 3 )$$

Using Equations 1, 2, and 3, an income at time t is determined by dividing a portfolio value by the index level to arrive at Equation 4, where σ_{p,c}=σ_{c,p}=σₚσ_{c}ρ is the covariance between P and C. Equation 4 consists of three terms: an initial income I₀ which can be calculated from today's portfolio value and future cost of retirement index level; the term in brackets which captures the impact of additional savings; and the exponential term which captures the residual return of a portfolio with respect to a future cost of retirement index. The notation of Equation 4 has been simplified by defining a holding vector h (Equation 5), a return vector R (Equation 6), a variance vector s² (Equation 7), and a covariance matrix V (Equation 8).

$$\begin{matrix}{I}_{t} = {I}_{0} [ \frac{{S}_{0} ( {e}^{( k - {r}_{p} ) t} - 1 ) + k - {r}_{p}}{k - {r}_{p}} ] {e}^{{h}^{′} ( R - \frac{{σ}^{2}}{2} ) t + \sqrt{{h}^{′} Vh} {B}_{t}} & ( 4 ) \\ h = ( \begin{matrix}1 \\ - 1\end{matrix} ) & ( 5 ) \\ R = ( \begin{matrix}{r}_{p} \\ {r}_{c}\end{matrix} ) & ( 6 ) \\ {σ}^{2} = ( \begin{matrix}{σ}_{p}^{2} \\ {σ}_{c}^{2}\end{matrix} ) & ( 7 ) \\ V = ( \begin{matrix}{σ}_{p}^{2} & {σ}_{p , c} \\ {σ}_{c , p} & {σ}_{c}^{2}\end{matrix} ) & ( 8 )\end{matrix}$$

Income distribution in this example is log normal with an expected value determined by Equation 9 and the variance determined by Equation 10. These equations then are used to determine 216 the range of likely retirement incomes for a given confidence interval (e.g., 50%).

$$\begin{matrix}E [ {I}_{t} ] = {I}_{0} [ \frac{{S}_{0} ( {e}^{( k - {r}_{p} ) t} - 1 ) + k - {r}_{p}}{k - {r}_{p}} ] {e}^{( {h}^{′} ( R - \frac{{σ}^{2}}{2} ) + \frac{{h}^{′} Vh}{2} ) t} & ( 9 ) \\ {σ}_{{I}_{t}}^{2} = {( {I}_{0} [ \frac{{S}_{0} ( {e}^{( k - {r}_{p} ) t} - 1 ) + k - {r}_{p}}{k - {r}_{p}} ] )}^{2} ( {e}^{{h}^{′} Vht} - 1 ) {e}^{( 2 {h}^{′} ( R - \frac{{σ}^{2}}{2} ) + {h}^{′} Vh ) t} & ( 10 )\end{matrix}$$

### Determining a Savings Level for Achieving a Lifetime Income Goal

To determine how much pre-retirement saving is needed to achieve a target income I_{T} in T years, Equation 9 is solved for S₀*, as shown in Equation 11.

$${S}_{0}^{*} = \frac{k - {r}_{p}}{{e}^{( k - {r}_{p} ) T} - 1} [ \frac{{I}_{T}}{{I}_{0}} {e}^{- ( {h}^{′} ( R - \frac{{σ}^{2}}{2} ) + \frac{{h}^{′} Vh}{2} ) T} - 1 ] \qquad ( 11 )$$

That is, solving Equation 11 for S₀*, for a selected target future income, will provide an initial savings rate S₀* (as a proportion of portfolio value) to be saved over T years that is likely to be sufficient to achieve the target future income goal in expectation.

### Determining Income Variation and Savings Rate Using Multiple Investment Types

One benefit of embodiments described herein is determining a range of expected values of future retirement income based on a savings rate. However, the expected value, and the range, will vary depending on the investments that constitute the portfolio. Generally, higher yielding investments have greater volatility and a potential for greater financial gain. Similarly, lower yielding investments generally have less volatility and potential for lesser financial gain. As such, the models underlying the planning tool can incorporate investment type (e.g., risk level, asset class) to produce the sophisticated analysis presented to a user by the planning tool and as illustrated in FIGS. 1B to 1D.

In one example, this can be accomplished by collecting expected returns and variances for m investment strategies into a vector r as shown in Equation 12.

r=(r₁r₂ . . . rₘ₋₁rₘ)′ (12)

A vector R, the “full return vector” includes a CORI return r_{c} in the vector r, as shown in Equation 13.

$$R = ( \begin{matrix}r \\ {r}_{c}\end{matrix} ) \qquad ( 13 )$$

To obtain the covariance matrix V (see Equation 8), the covariances among all m investment strategies are combined with the covariance of each investment strategy with r_{c}, the rate of change of the cost of retirement index. This produces covariance matrix V, as shown in Equation 14.

$$V = ( \begin{matrix}{σ}_{1}^{2} & {σ}_{1 , j} & {σ}_{1 , m} & {σ}_{1 , c} \\ {σ}_{i , 1} & {σ}_{i}^{2} & {σ}_{i , m} & {σ}_{i , c} \\ {σ}_{m , 1} & {σ}_{m , j} & {σ}_{m}^{2} & {σ}_{m , c} \\ {σ}_{c , 1} & {σ}_{c , j} & {σ}_{c , m} & {σ}_{c}^{2}\end{matrix} ) \qquad ( 14 )$$

The percentage exposure of a portfolio to each strategy is identified in vector x, as shown in Equation 15.

x=(x₁x₂ . . . xₘ₋₁xₘ)′ (15)

An exposure matrix X is defined in Equation 16.

$$X = ( \begin{matrix}x & 0 \\ 0 & 1\end{matrix} ) \qquad ( 16 )$$

Analogs of the single-fund return vector, variance vector, and covariance vectors are then determined for this multi-fund scenario according to Equations 17 to 19.

\tilde{R}=X′R (17)

\tilde{V}=X′VX (18)

\tilde{σ}\tilde{σ²}=Diag(X′VX) (19)

Using the above, the expected value and variance of a log normal income distribution are expressed as shown in Equations 20 and 21.

$$\begin{matrix}E [ {I}_{t} ] = {I}_{0} [ \frac{{S}_{0} ( {e}^{( k - {x}^{′} r ) t} - 1 ) + k - {x}^{′} r}{k - {x}^{′} r} ] {e}^{( {h}^{′} ( \tilde{R} - \frac{{\tilde{σ}}^{2}}{2} ) + \frac{{h}^{′} \tilde{V} h}{2} ) t} & ( 20 ) \\ {σ}_{{I}_{t}}^{2} = {( {I}_{0} [ \frac{{S}_{0} ( {e}^{( k - {x}^{′} r ) t} - 1 ) + k - {x}^{′} r}{k - {x}^{′} r} ] )}^{2} ( {e}^{{h}^{′} \tilde{V} ht} - 1 ) {e}^{( 2 {h}^{′} ( \tilde{R} - \frac{{\tilde{σ}}^{2}}{2} ) + {h}^{′} \tilde{V} h ) t} & ( 21 )\end{matrix}$$

Using these, the initial savings rate to reach an expected value of a retirement target income is shown in Equation 22.

$${S}_{0}^{*} = \frac{k - {x}^{′} r}{{e}^{( k - {x}^{′} r ) T} - 1} [ \frac{{I}_{T}}{{I}_{0}} {e}^{- ( {h}^{′} ( \tilde{R} - \frac{{\tilde{σ}}^{2}}{2} ) + \frac{{h}^{′} \tilde{V} h}{2} ) T} - 1 ] \qquad ( 22 )$$

In choosing among some examples of investment strategies, weights of x are selected to minimize required annual savings (maximize return) and minimize the standard deviation of retirement income. An objective function is shown in Equation 23 where λ is a risk aversion parameter.

$${min}_{x} u = {P}_{0} {S}_{0}^{*} + λ {σ}_{{I}_{T}} \qquad ( 23 )$$

### Example Application

The following example illustrates using Equation 22 to assist an investor in determining the answers to three questions: (1) How much does the investor need to save annually over the next 10 years to fund a retirement goal? (2) What is the range of annual incomes the investor might expect for any given investment plan? (3) What is the portfolio that minimizes the required savings while giving the investor a targeted level of uncertainty in annual income?

For the following example, an investor is assumed to be 55 years old, have $670,000 in present retirement savings, and have a target retirement income of $75,000 per year. A cost of retirement index for retirement year of 2024 is assumed to have a value of $12.88. Using these values with Equation 1, a future annual retirement income of $52,000 could be purchased by the investor. This is $23,000 short of the targeted retirement income goal.

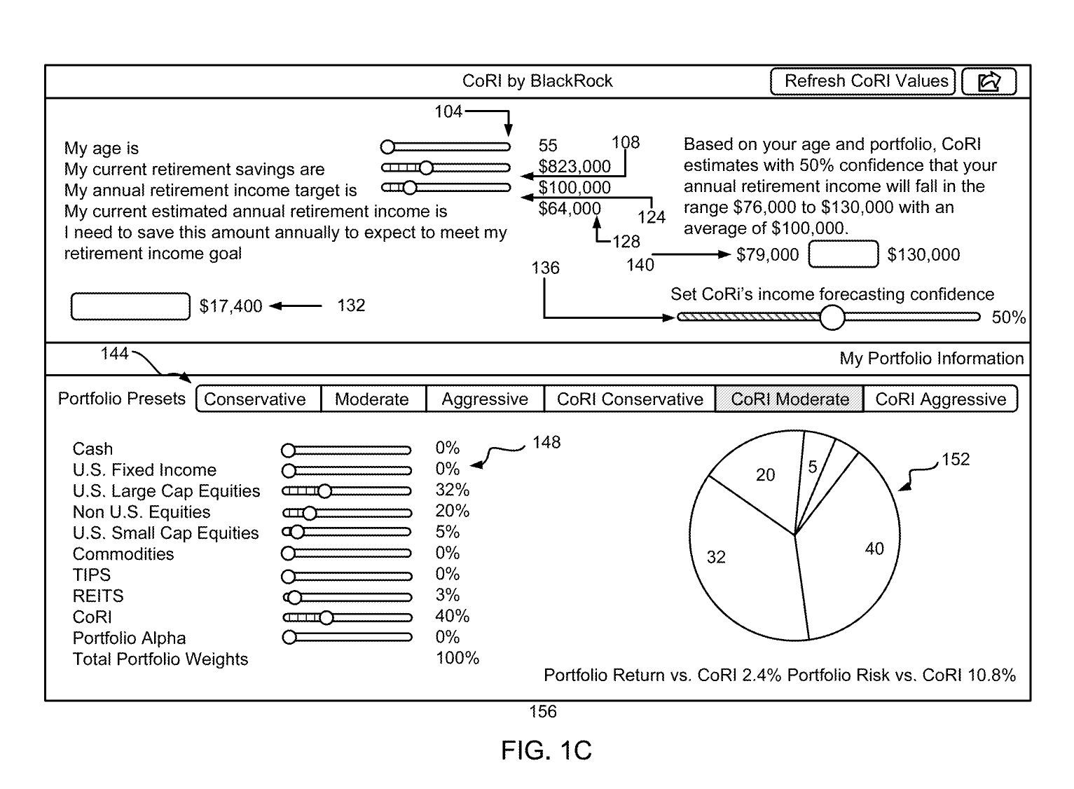

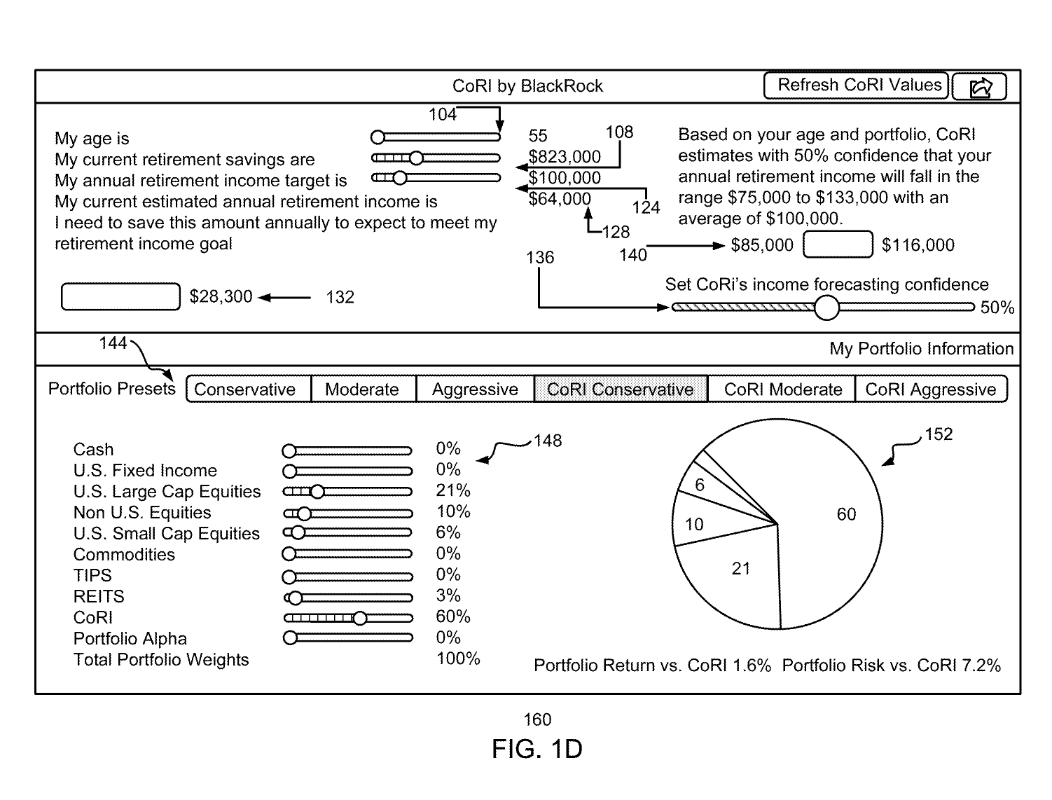

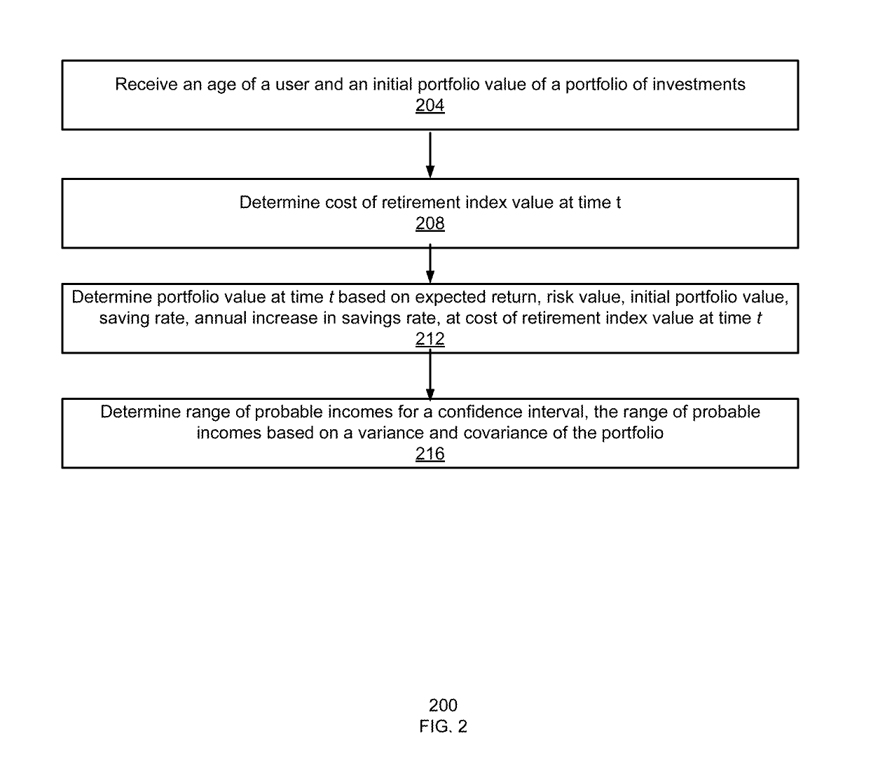

FIGS. 3 and 4 illustrate various characterizations of asset classes and can be used to develop options of portfolios having different investing strategies corresponding to different risk tolerances. Using Equation 22, FIG. 5 illustrates two example portfolios that can be selected by an investor. In both example portfolios, no investments are selected that include a cost of retirement index fund.

As is shown in FIG. 5, a moderate portfolio selection indicates the investor should save $14,000 annually and expect a lump-sum invested at retirement to provide an annual retirement income between $48,000 and $117,000 about two-thirds of the time. Selecting the more aggressive portfolio, the investor can expect to save $4,000 annually and expect a lump-sum invested at retirement to generate between $45,000 and $125,000 per year two-thirds of the time. Investing in a more aggressive portfolio allows the investor to save less to reach the goal in expectation, but at the cost of greater uncertainty around the target level of income.

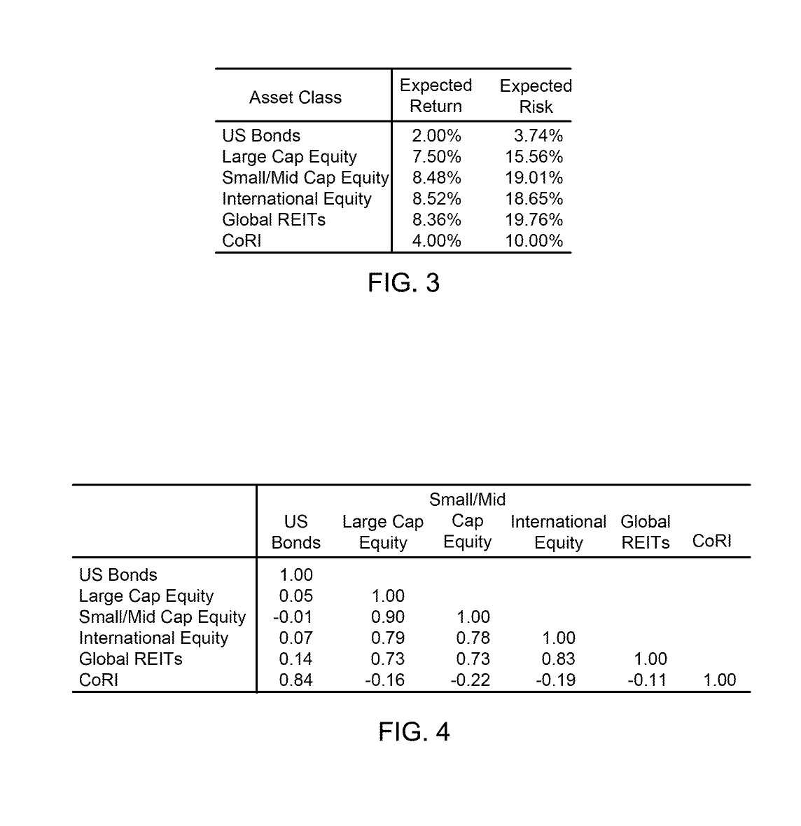

As shown in FIG. 6, a bond investment allocation of the previously described portfolio selection is replaced by an allocation to a fund that tracks a future cost of retirement index. In both cases an allocation to a future cost of retirement index fund allows the investor to achieve a lower level of income volatility with a lower required level of annual savings.

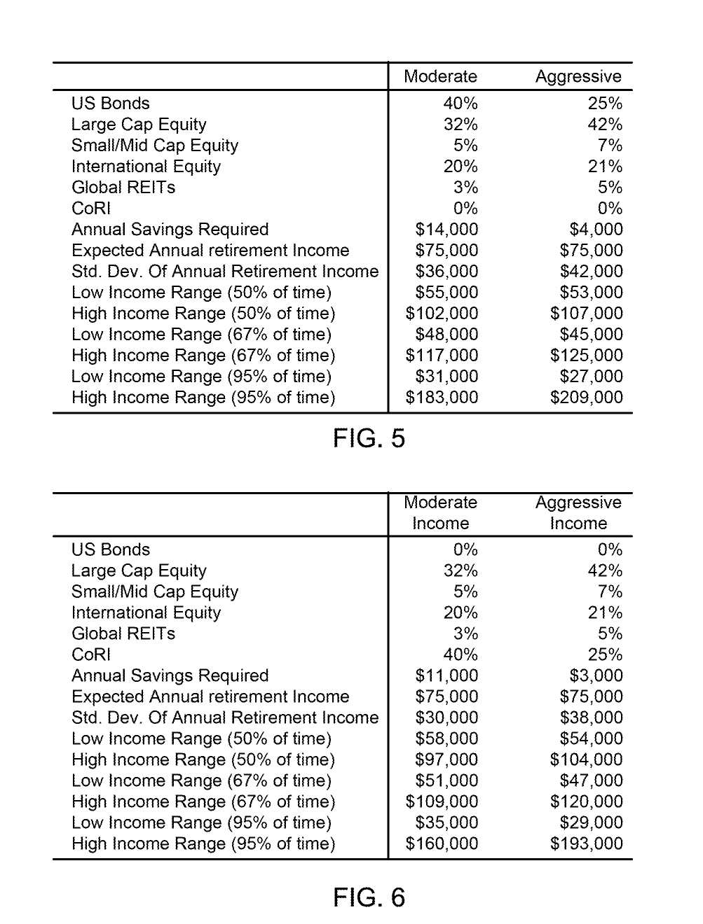

FIG. 7 illustrates a convenient way of communicating the expected performance of a broader range of portfolios. Each point on the lines in FIG. 7 is a portfolio that minimizes savings for a given level of income volatility. The top line represents portfolios that do not contain an allocation to a future cost of retirement index fund, and the bottom line allows for unconstrained allocations to a future cost of retirement index fund. It is clear that allowing for an allocation to future cost of retirement index funds unambiguously lowers income volatility for a given level of savings, with the benefit at its highest for those who are particularly averse to variability in their retirement income. FIG. 7 also shows the four investment options described above. By allocating the fixed income portion of a portfolio to a future cost of retirement index fund, the investor moves from the top line to the bottom line, improving outcomes in terms of the trade-off between required savings and income volatility.

### System Architecture

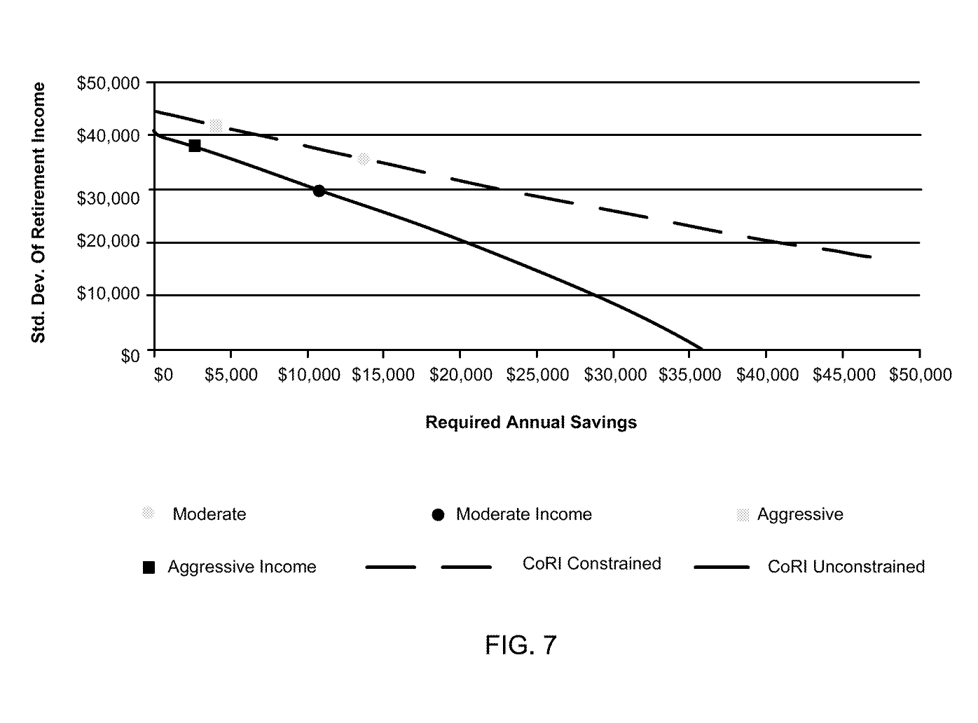

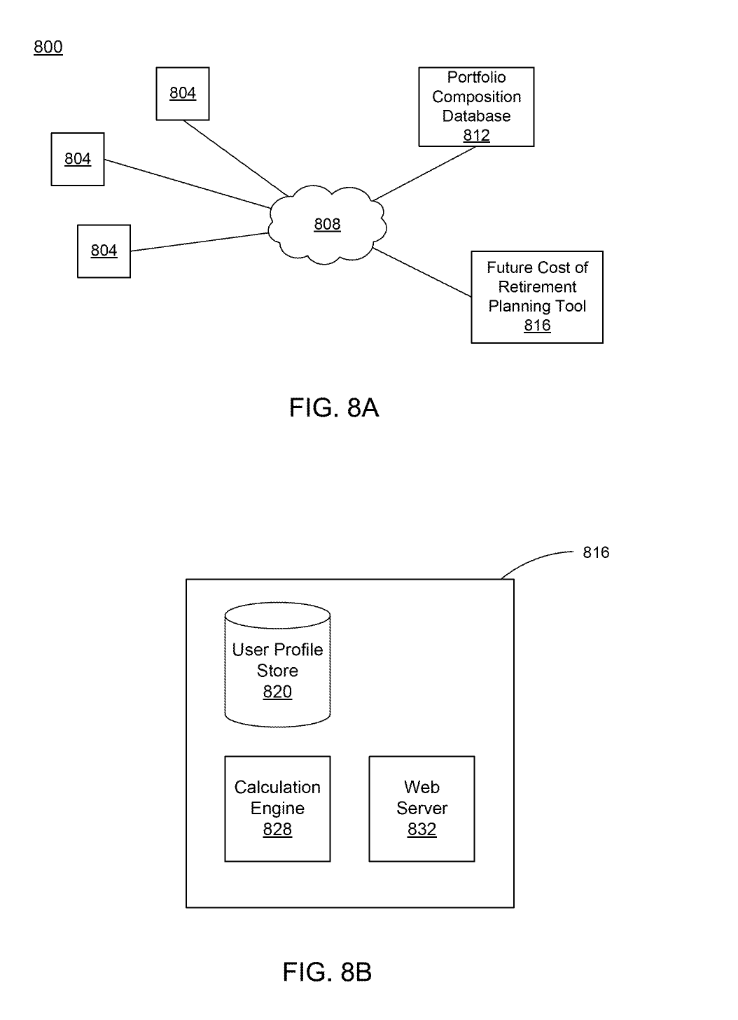

FIG. 8A is a high level block diagram of a system environment 800 for a future cost of retirement planning tool system that is configured to perform the various methods described above. The system environment 800 shown by FIG. 8A comprises one or more client devices 804, a network 808, a portfolio composition database 812, and a future cost of retirement planning tool 816. In alternative configurations, different and/or additional components may be included in the system environment 800.

The client devices 804 are one or more computing devices capable of receiving user input as well as transmitting and/or receiving data via the network 808. In one embodiment, a client device 804 is a conventional computer system, such as a desktop or laptop computer. Alternatively, a client device 804 may be a device having computer functionality, such as a personal digital assistant (PDA), a mobile telephone, a smartphone or another suitable device. A client device 804 is configured to communicate via the network 808. In one embodiment, a client device 808 executes an application allowing a user of the client device 808 to interact with the future cost of retirement planning tool 816. For example, a client device 804 executes a browser application to enable interaction between the client device 804 and the future cost of retirement planning tool 816 via the network 808. In another embodiment, a client device 804 interacts with the future cost of retirement planning tool 816 through an application programming interface (API) running on a native operating system of the client device 804, such as IOS® or ANDROID™.

The client devices 804 are configured to communicate via the network 808, which may comprise any combination of local area and/or wide area networks, using both wired and/or wireless communication systems. In one embodiment, the network 808 uses standard communications technologies and/or protocols. For example, the network 808 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 808 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 808 may be represented using any suitable format, such as hypertext markup language (HTML) or extensible markup language (XML). In some embodiments, all or some of the communication links of the network 808 may be encrypted using any suitable technique or techniques.

One or more third party systems, such as portfolio composition database 812, may be coupled to the network 808 for communicating with the future cost of retirement planning tool 816 and/or the client devices 804, as described above. In the example shown in FIG. 8A, portfolio composition database 812 provides information describing specific investments, entire portfolios, and their corresponding risks and investment performance for use by the future cost of retirement planning tool 816 in determining a future cost of retirement and range of future retirement incomes for a given confidence level, as described above. The depiction of the portfolio composition database 812 is illustrative only. In other embodiments, the portfolio composition database 812 can be integrated within the future cost of retirement planning tool 816 itself. In still further embodiments, databases different from (or in addition to) the portfolio composition database 812 are external to, but in communication with, the future cost of retirement planning tool 816 via the network 808 and are used by the future cost of retirement planning tool 816 to access data used for determining the future cost of retirement index, retirement incomes and ranges, and other parameters as described above.

FIG. 8B is an example block diagram of an architecture of the future cost of retirement planning tool 816. The future cost of retirement planning tool 816 shown in FIG. 8B includes a user profile store 820, a CoRI portofolio store 824, a calculation engine 828, and a web server 832. In other embodiments, future cost of retirement planning tool 816 may include additional, fewer, or different components for various applications. Conventional components such as network interfaces, security functions, load balancers, failover servers, management and network operations consoles, and the like are not shown so as to not obscure the details of the system architecture.

The user profile store 820 stores various data provided by a user and received through, for example, a client device 804. The data received from the user is used by the future cost of retirement planning tool 816 in cooperation with other data to determine future cost of retirement, and other parameters, as described above. Examples of data provided by the user and stored in the user profile store 820 include, but are not limited to, investor age, future retirement date, current retirement savings amount, and risk preference, as described above.

The calculation engine 828 uses data received from the user and stored in the user profile store 820, the portfolio composition database 812, and other sources of information to determine a future cost of retirement index, a range of future retirement incomes, and various other parameters, as described above.

The web server 832 links the future cost of retirement planning tool 816 via the network 808 to the one or more client devices 804, as well as to the one or more third party systems (e.g., portfolio composition database 812). The web server 832 serves web pages, as well as other web-related content, such as JAVA®, FLASH®, XML and so forth. The web server 832 may receive and route messages between the future cost of retirement planning tool 816 and the client device 804, for example, instant messages, queued messages (e.g., email), text messages, short message service (SMS) messages, or messages sent using any other suitable messaging technique. Additionally, the web server 832 may provide application programming interface (API) functionality to send data directly to native client device operating systems, such as IOS®, ANDROID™, WEBOS® or RIM®.

### Further Considerations

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A computer-implemented method comprising:
receiving, at a client device, an age of a user at a first date, an initial portfolio value at the first date, and a future target date;
determining a future cost of retirement index value as a function of time based on the received age of the user, the future cost of retirement index corresponding to an expected amount of present value for purchasing a fixed amount of income for life at the future target date;
determining a portfolio value as a function of time based on at least the initial portfolio value, and the future cost of retirement index value as a function of time;
determining an estimated future annual retirement income at the future target date by dividing the portfolio value at the future target date by the future cost of retirement index amount at the future target date; and
determining a range of probable retirement incomes at the future target date based on the estimated future annual retirement income and a confidence interval.

2. The computer-implemented method of claim 1, wherein determining the portfolio value as a function of time is based on a portfolio composition, an expected annual rate of return corresponding to the portfolio composition, and an annual increase in a savings rate of the user.

3. The computer-implemented method of claim 1, wherein the cost of retirement index value as a function time is based on an initial index level at an initial time, and a Brownian motion term.

4. The computer-implemented method of claim 1, further comprising receiving an annual income target beginning on the future target date.

5. The computer-implemented method of claim 1, wherein determining the range of probable retirement incomes for the confidence interval is based on a return vector, a variance, and a covariance.

6. The computer-implemented method of claim 1, further comprising displaying the estimated future annual retirement income at the future target date and displaying the range of probable incomes.

7. The computer-implemented method of claim 1, further comprising determining a pre-retirement savings amount needed to achieve the estimated future annual retirement income target at the future target date.

8. The computer-implemented method of claim 7, wherein the future annual retirement income target at the future target date is based on a pre-retirement savings rate as a proportion of portfolio value, a number of years of savings, an expected return of the portfolio, a desired percentage increase in annual savings rate, a return vector, a holding vector, an initial income, future cost of retirement index level, and a covariance matrix.

9. The computer-implemented method of claim 1, further comprising determining an amount of additional annual savings for achieving the estimated future annual retirement income based on the age of the user at the first date, the initial portfolio value, the future retirement date, a portfolio composition, and the confidence interval.

10. A system comprising:
a user profile store configured for receiving an age of a user at a first date, an initial portfolio value at the first date, and a future target date;
a calculation engine configured for:
determining a future cost of retirement index value as a function of time based on the received age of the user, the future cost of retirement index corresponding to an expected amount of present value for purchasing a fixed amount of income for life at the future target date;
determining a portfolio value as a function of time based on at least the initial portfolio value, and the future cost of retirement index value as the function of time;
determining an estimated future annual retirement income at the future target date by dividing the portfolio value at the future target date by the future cost of retirement index amount at the future target date;
determining a range of probable retirement incomes at the future target date based on the estimated future annual retirement income and a confidence interval; and
a web server configured for providing for display the estimated future annual retirement income at the future target date and the range of probable retirement incomes.

11. The system of claim 10, wherein the web server is further configured for receiving a portfolio composition from a portfolio composition database.

12. The system of claim 11, wherein the calculation engine is further configured for determining the portfolio value as a function of time is based on the portfolio composition, an expected annual rate of return corresponding to the portfolio composition, and an annual increase in a savings rate of the user.

13. The system of claim 10, wherein the calculation engine determines the cost of retirement index value as a function time based on an initial index level at an initial time, and a Brownian motion term.

14. The system of claim 10, wherein the user profile store is further configured for receiving an annual income target beginning on the future target date.

15. The system of claim 10, wherein the calculation engine is further configured for determining the range of probable retirement incomes for the confidence interval is based on a return vector, a variance, and a covariance.

16. The system of claim 10, wherein the web server is further configured for providing for display the estimated future annual retirement income at the future target date and the range of probable incomes.

17. The system of claim 10, wherein the calculation engine is further configured for determining a pre-retirement savings amount needed to achieve the estimated future annual retirement income target at the future target date.

18. The system of claim 17, wherein calculation engine determines the future annual retirement income target at the future target date based on a pre-retirement savings rate as a proportion of portfolio value, a number of years of savings, an expected return of the portfolio, a desired percentage increase in annual savings rate, a return vector, a holding vector, an initial income, future cost of retirement index level, and a covariance matrix.

19. The system of claim 10, wherein the calculation engine is further configured for determining an amount of additional annual savings for achieving the estimated future annual retirement income based on the age of the user at the first date, the initial portfolio value, the future retirement date, a portfolio composition, and the confidence interval.
